(19) United States
(12) Patent Application Publication
(10) Pub. No.: US 2016/0306802 A1
(43) Pub. Date: Oct. 20, 2016

(54) METHOD AND SERVER FOR PROVIDING CONTENTS SERVICE

(71) Applicant: FOUNDATION OF SOONGSIL UNIVERSITY INDUSTRY COOPERATION, Seoul (KR)

(72) Inventors: Kee Chul JUNG, Seoul (KR); Kwang Jin HONG, Seongnam-si (KR); Mi Rim KWON, Seoul (KR); Hye Song RYU, Seoul (KR)

(21) Appl. No.: 15/134,038

(22) Filed: Apr. 20, 2016

(30) Foreign Application Priority Data
Apr. 20, 2015 (KR) 10-2015-0055279

(51) Int. Cl. G06F 17/30

(52) U.S. Cl. CPC G06F 17/3053; G06F 17/30598; G06F 17/30554

(57) ABSTRACT

A method and a server for providing a contents service are disclosed. The method of providing a content service through a service server comprises (a) storing a registration keyword and a URL address with matching the registration keyword and the URL address with pre-existing index according to hierarchical classification information in the event that a registration request of contents including the URL address of the contents, the hierarchical classification information preset for the contents and at least one registration keyword is received from a first user terminal; and (b) searching an index matched with a search keyword and providing the searched index to a second user terminal in the event that a search request of contents including the search keyword is received from the second user terminal.

### TECHNICAL FIELD

The present disclosure relates to a method and a server for providing contents service, more particularly a technique for providing contents made by individual with a standardized contents service.

### BACKGROUND ART

Recently, a service, such as Wikipedia or Pinterest, etc., in which users share voluntarily information has been greatly popular.

This is a system where unspecified users complete contents (description) concerning specific word or collect only desired image of images as a writer or an editor.

However, the service for voluntarily sharing the information can't apply sanctions even when the writer or the editor copies simply other person's contents, and thus it is difficult to protect a copyright about the contents and common index among the users may not be shared.

### SUMMARY

To solve problem of the convention technique, the invention is to provide a method of providing contents related to corresponding keyword in index type with protecting a copyright about original contents when the contents related to specific keyword is provided.

A method of providing a content service through a service server according to one embodiment of the invention comprises (a) storing a registration keyword and a URL address with matching the registration keyword and the URL address with pre-existing index according to hierarchical classification information in the event that a registration request of contents including the URL address of the contents, the hierarchical classification information preset for the contents and at least one registration keyword is received from a first user terminal; and (b) searching an index matched with a search keyword and providing the searched index to a second user terminal in the event that a search request of contents including the search keyword is received from the second user terminal. Here, the searched index includes one or more low rank classifications in hierarchical type, and an index corresponding to lowest rank classification includes the URL address capable of accessing to corresponding contents.

A service server for providing a contents service according to one embodiment of the invention comprises a sharing contents registration unit configured to store a registration keyword and a URL address with matching the registration keyword and the URL address with pre-existing index according to hierarchical classification information in the event that a registration request of contents including the URL address of the contents, the hierarchical classification information preset for the contents and at least one registration keyword is received from a first user terminal; and a sharing contents providing unit configured to search an index matched with a search keyword and provide the searched index to a second user terminal in the event that a search request of contents including the search keyword is received from the second user terminal. Here, the searched index includes one or more low rank classifications in hierarchical type, and an index corresponding to lowest rank classification includes the URL address capable of accessing to corresponding contents.

A method of providing a contents service through a user terminal according to one embodiment of the invention comprises (a) receiving a search keyword; and (b) transmitting the inputted search keyword to a service server, receiving a search result matched with the search keyword from the service server and displaying the received search result. Here, the search result includes one or more low rank classifications as an index in hierarchical type, and an index corresponding to lowest rank classification includes a URL address capable of accessing to corresponding contents.

In one embodiment of the invention, original contents is provided in index type when contents related to specific keyword is provided, and thus a user may verify clearly the contents related to the keyword.

Additionally, it is possible to access to the contents according to a link address of the original contents, and so it is impossible to edit the original contents. Accordingly, the method may protect easily a copyright about the contents.

Effect of the invention is not to effect mentioned above, and may include every effect capable of being inferred from description or claims of the invention.

### BRIEF DESCRIPTION OF DRAWINGS

Example embodiments of the present invention will become more apparent by describing in detail example embodiments of the present invention with reference to the accompanying drawings, in which:

FIG. 1 is a block diagram illustrating a system for providing a contents service according to one embodiment of the invention;

FIG. 2 is a block diagram illustrating a service server according to one embodiment of the invention;

FIG. 3 is a flow chart illustrating a process of providing a contents service according to one embodiment of the invention;

FIG. 4 is a view illustrating a contents service usage process according to one embodiment of the invention; and

FIG. 5 is a view illustrating a usage result of the contents service according to one embodiment of the invention.

### DETAILED DESCRIPTION

Hereinafter, the invention will be described with reference to accompanying drawings. The invention is susceptible to various modifications and alternative forms, it should be understood, however, that there is no intent to limit the invention to the particular forms disclosed.

A section unrelated to description for describing distinctively the invention will be omitted, and like numbers refer to like elements throughout the description of the figures.

It will be understood that when an element is referred to as being “connected” or “coupled” to another element, it can be directly connected or coupled to the other element or intervening elements may be present.

It will be understood that the terms “comprises”, “comprising,”, “includes” and/or “including”, when used herein, specify the presence of stated features, integers, steps, operations, elements, and/or configurations, but do not preclude the presence or addition of one or more other features, integers, steps, operations, elements, configurations, and/or groups thereof.

Hereinafter, various embodiments of the invention will be described in detail with reference to accompanying drawings.

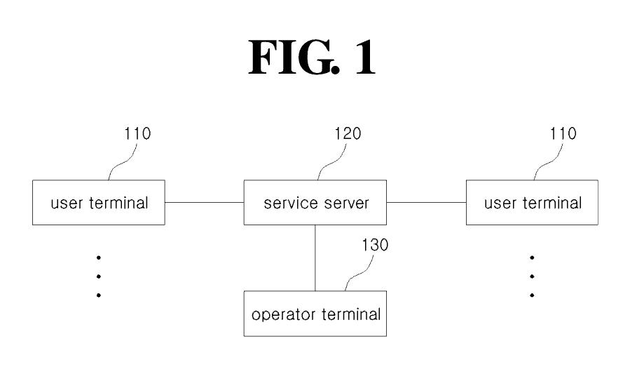

FIG. 1 is a block diagram illustrating a system for providing a contents service according to one embodiment of the invention.

The system 100 of providing the contents service of the present embodiment includes a user terminal 110, a service server 120 and an operator terminal 130.

The user terminal 110 may register contents (hereinafter, referred to as “sharing contents”) provided through specific web page to the service server 120.

The user terminal 110 may input an URL address of a web page including the sharing contents, hierarchical classification information (e.g. classification of large, medium and small) of the sharing contents and at least one keyword related to the sharing contents (hereinafter, referred to as “registration keyword”), transmit the inputted information to the service server 120, and display a first user interface through which a user can request registration of the sharing contents on a screen.

Here, the URL address may be automatically inputted on the first user interface through a plug-in method, and be inputted by the user.

The user terminal 110 may input a keyword (hereinafter, referred to as “search keyword”) related to the sharing contents for the purpose of requesting the sharing contents, transmit the inputted search keyword to the service server 120, and display a second user interface through which the user can request the sharing contents on the screen.

Here, according to requesting of the sharing contents, the user may receive sharing contents pre-registered by other users as well as sharing contents pre-registered himself.

The user terminal 110 may receive search result matched with the search keyword from the service server 120 and display the received search result on the screen.

Here, the search result matched with the search keyword may be provided in index type, and at least one low level category or the URL address for providing the sharing contents may be shown when specific category is selected.

In one embodiment, an index corresponding to lowest rank classification includes the URL address capable of accessing to corresponding contents

The user terminal 110 may include a mobile communication terminal such as a smart phone, a portable phone, a personal digital assistant PDA, a portable multimedia player PMP, a tablet computer, etc. and every terminal, such as a laptop computer, a desktop computer, a TV connected to a set-top box, etc., which can be connected to the service server 120 through a network.

On the other hand, the service server 120 may transmit an application install file to the user terminal 110 according to request of the user terminal 110, and receive a registration request of the sharing contents from the user terminal 110 in which the application is installed.

Here, the registration request of the sharing contents may include the URL address of the web page including the sharing contents, the hierarchical classification information (e.g. classification of large, medium and small) of the sharing contents and at least one registration keyword.

In the event that the registration request of the sharing contents is received, the service server 120 may perform duplication check of the URL address, generation of shortened URL address and a data classification process using the registration keyword.

Here, data classification using the registration keyword may be performed based on an edit distance algorithm about an index generated in advance, and the index generated in advance may be stored with a keyword, which is shown in an annotation, representing the index.

In the event that a provision request of the sharing contents is received from the user terminal 110, the service server 120 may provide search result, in index type, matched with search keyword included in the provision request to the user terminal 110.

The operator terminal 130 may transmit an index generation request including the index, the hierarchical classification information (e.g. classification of large, medium and small) and at least one keyword related to corresponding index to the service server 120 and generate various indexes according to the category in response to the transmitted index generation request.

The operator terminal 130 may request classification about unclassified registration keyword and generation of relative index.

The operator terminal 130 may include a mobile communication terminal such as a smart phone, a portable phone, a PDA, a PMP, a tablet computer, etc. and every terminal, such as a laptop computer, a desktop computer, a TV connected to a set-top box, etc., which can be connected to the service server 120 through a network.

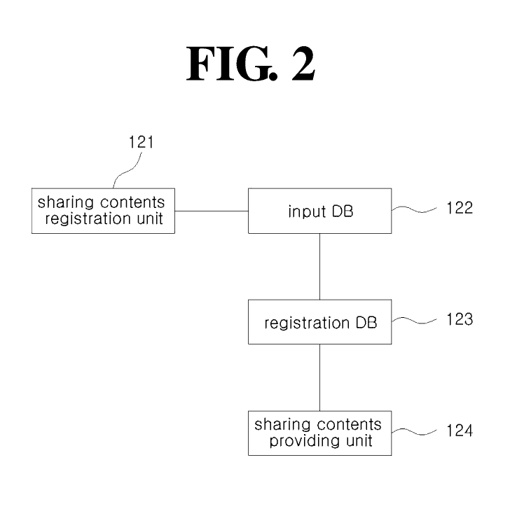

FIG. 2 is a block diagram illustrating a service server according to one embodiment of the invention.

The service server 120 of the present embodiment includes a sharing contents registration unit 121, an input database 122, a registration database 123 and a sharing contents providing unit 124.

The sharing contents registration unit 121 may store the URL address of the web page including the sharing contents, the hierarchical classification information (e.g. classification of large, medium and small) of the sharing contents and at least one registration keyword in the input database 122 in the event that it receives a registration request of the sharing contents from the user terminal 110.

The sharing contents registration unit 121 may analyze and process the information stored in the input database 122 and store result of the analyzing and the processing in the registration database 123, thereby registering the sharing contents requested by the user.

Here, the analyzing and the processing may include one or more of the duplication check of the URL address, the generation of the shortened URL of corresponding URL address and the data analysis using the registration keyword, and the sharing contents registration unit 121 may classify the registration keyword based on the edit distance algorithm about the index generated in advance.

The index may be generated by classified according to category or hierarchy (e.g. large, medium and small) in response to request of the operator terminal 130, and be stored with the keyword, which is shown in an annotation, related to the index.

Accordingly, an edit distance about the index may mean an edit distance between relative keyword, stored as the annotation with the index when the index is generated, and the registration keyword included in the registration request of the sharing contents.

The input database 122 may store the URL address of the web page including the sharing contents received from the user terminal 110, the hierarchical classification information (e.g. classification of large, medium and small) of the sharing contents and at least one registration keyword.

The registration database 123 may include one or more of the shortened URL address of the URL address stored in the input database 122, the at least one registration keyword and the index information matched with corresponding registration keyword, as the result stored after analyzing and processing the information stored in the input database 122 by the sharing contents registration unit 121.

The sharing contents providing unit 124 may search a search result in index type matched with the search keyword included in the provision request of the sharing contents from the registration database 123 and provide the search result to the user terminal 110, in the event that the provision request of the sharing contents is received from the user terminal 110.

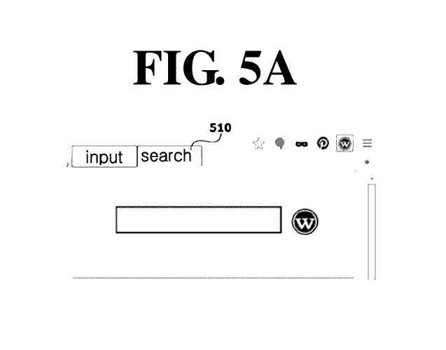

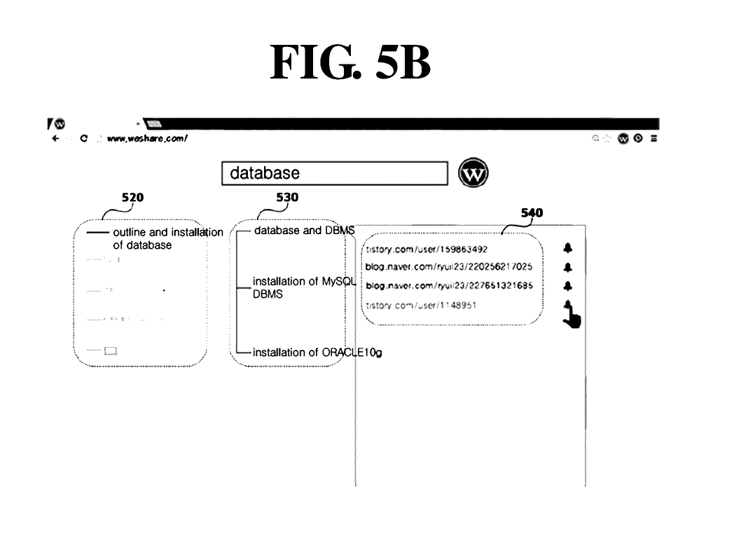

The search result in index type matched with the search keyword will be described with reference to accompanying drawing FIG. 5.

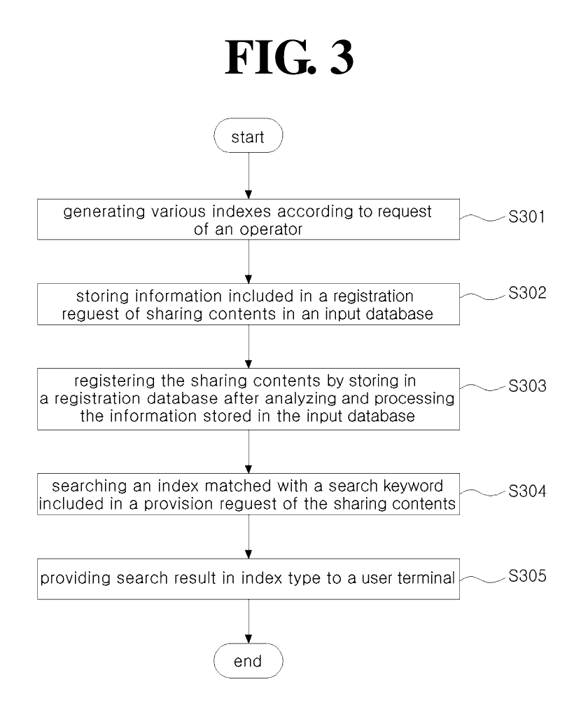

FIG. 3 is a flow chart illustrating a process of providing a contents service according to one embodiment of the invention.

The process in FIG. 3 may be performed by the service server 120 in FIG. 2. Hereinafter, the process in FIG. 3 will be described under the condition that the service server 120 performs the process.

In a step of S301, the service server 120 receives the index, the hierarchical classification information (e.g. classification of large, medium and small) and the keyword related to corresponding index from the operator terminal 130 and generates various indexes according to category.

In a step of S302, the service server 120 stores the URL address of the web page included in the registration request of the sharing contents, the hierarchical classification information (e.g. classification of large, medium and small) of the sharing contents and the at least one registration keyword in the input database 122 in the event that the registration request of the sharing contents is received from the user terminal 110.

In a step of S303, the service server 120 registers the sharing contents requested by the user by analyzing and processing the information stored in the input database 122 and then storing the result of the analyzing and the processing in the registration database 123.

In this case, the service server 120 may perform data analysis using the duplicate check of the URL address, the generation of the shortened URL of corresponding URL address and the registration keyword.

In a step of S304, the service server 120 searches the index matched with the search keyword included in a provision request of the sharing contents from the registration database 123, in the event that the provision request of the sharing contents is received from the user terminal 110.

In a step of S305, the service server 120 provides the searched index (result in index type) to the user terminal 110.

Here, the index (result in index type) provided to the user terminal 110 may include the URL address, and the user terminal 110 may access to the sharing contents using corresponding URL address.

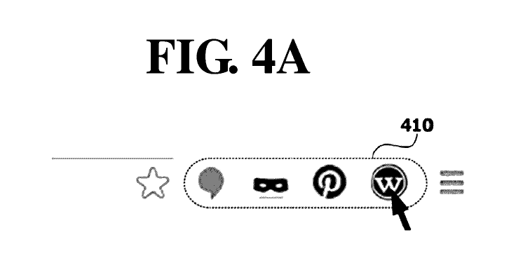

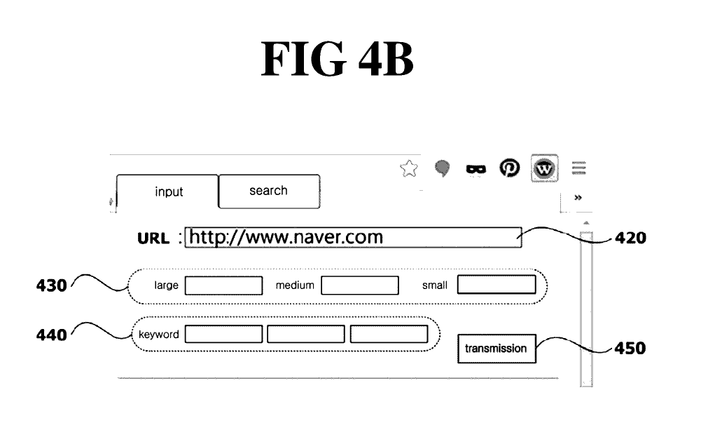

FIG. 4 is a view illustrating a contents service usage process according to one embodiment of the invention.

(a) in FIG. 4 shows a screen displayed by executing a browser after an application is installed to the user terminal 110.

As shown in (a) in FIG. 4, an icon 410 capable of using the contents service of the invention may be shown on an upper part of the browser.

(b) in FIG. 4 shows a screen when the user shares contents of a web page, displayed on present screen of data search using the user terminal 110, as the sharing contents with other person.

In the event that the icon 410 on the upper part of the browser is selected, an URL address of the web page displayed on the present screen may be automatically inputted in an URL address input window 420 as shown in (b) in FIG. 4. Of course, the user may input directly the URL address.

The user may transmit the registration request of the sharing contents to the service server 120, by selecting large, medium or small classification 430 which is the hierarchical classification information of corresponding contents, inputting a keyword 440 related to corresponding contents and then clicking a transmission button 450.

FIG. 5 is a view illustrating a usage result of the contents service according to one embodiment of the invention.

FIG. 5 shows a screen when the user searches the sharing contents and receives desired sharing contents using the user terminal 110.

In the event that the icon 410 on the upper part of the browser shown in (a) in FIG. 4 is selected, the screen shown in (b) in FIG. 4 may be displayed. In the event that a search tap 510 is selected on the screen, a window capable of inputting search keyword may be displayed as shown in (a) in FIG. 5.

Database is inputted as the search keyword in FIG. 5, and the search result is shown in (b) in FIG. 5.

That is, a high rank index 520 as a keyword related to the database may be displayed as the search result on the screen of the user terminal 110, and a low rank index 530 of corresponding index may be displayed on the screen when one of the high rank index 520 is selected.

The sharing contents registered relative to corresponding index, i.e. an URL address 540 capable of accessing to the sharing contents may be displayed, and the user may access to the sharing contents through corresponding URL address.

A person having ordinary skill in the art would be able to make various modifications, alterations, and additions without departing from the spirit and scope of the invention, but it is to be appreciated that such modifications, alterations, and additions are encompassed by the scope of claims set forth below.

The embodiments of the invention described above are disclosed only for illustrative purposes.

For example, described techniques may be performed in different order from described methods, and/or elements such as above a system, a structure, a device, a circuit, etc. may be combined in different type in method mentioned above, or desired result may be achieved although the elements are replaced with other elements or equal elements.

Equality of other embodiments and claims are included in the scope of claims set forth below. Various variations and modifications are possible in the configuration parts and/or arrangements of the subject combination arrangement within the scope of the appended claims.

1. A method of providing a content service through a service server, the method comprising:
(a) storing a registration keyword and a URL address with matching the registration keyword and the URL address with pre-existing index according to hierarchical classification information in the event that a registration request of contents including the URL address of the contents, the hierarchical classification information preset for the contents and at least one registration keyword is received from a first user terminal; and
(b) searching an index matched with a search keyword and providing the searched index to a second user terminal in the event that a search request of contents including the search keyword is received from the second user terminal,
wherein the searched index includes one or more low rank classifications in hierarchical type, and an index corresponding to lowest rank classification includes the URL address capable of accessing to corresponding contents.

2. The method of claim 1, wherein the matching in the (a) step is performed according to an edit distance algorithm of the registration keyword and a keyword related to the pre-existing index.

3. The method of claim 1, wherein the (a) step includes one or more of a step of checking duplication of the URL address included in the registration request of the contents; and a step of generating a shortened URL address of the URL address.

4. A service server for providing a contents service comprising:
a sharing contents registration unit configured to store a registration keyword and a URL address with matching the registration keyword and the URL address with pre-existing index according to hierarchical classification information in the event that a registration request of contents including the URL address of the contents, the hierarchical classification information preset for the contents and at least one registration keyword is received from a first user terminal; and
a sharing contents providing unit configured to search an index matched with a search keyword and provide the searched index to a second user terminal in the event that a search request of contents including the search keyword is received from the second user terminal,
wherein the searched index includes one or more low rank classifications in hierarchical type, and an index corresponding to lowest rank classification includes the URL address capable of accessing to corresponding contents.

5. The service server of claim 4, wherein the sharing contents registration unit performs the matching by using an edit distance algorithm of the registration keyword and a keyword related to the pre-existing index.

6. A method of providing a contents service through a user terminal, the method comprising:
(a) receiving a search keyword; and
(b) transmitting the inputted search keyword to a service server, receiving a search result matched with the search keyword from the service server and displaying the received search result,
wherein the search result includes one or more low rank classifications as an index in hierarchical type, and an index corresponding to lowest rank classification includes a URL address capable of accessing to corresponding contents.

7. A method of claim 6, further comprising:
(c) accessing to a server corresponding to a selected URL address in the event that the URL address included in the index corresponding to the lowest rank classification is selected, receiving contents from the server and displaying the received contents on a screen.

8. A computer program stored in a medium including a series of instructions for performing the method according to claim 6.
